(19) United States
(12) Patent Application Publication
(10) Pub. No.: US 2009/0072649 A1
(43) Pub. Date: Mar. 19, 2009

(54) BRUSHLESS ELECTRIC MOTOR

(75) Inventor: Hans Herman Rottmerhusen, Tellingstedt (DE)

Correspondence Address: NORRIS, MCLAUGHLIN & MARCUS, 875 THIRD AVE, 18TH FLOOR, NEW YORK, NY, 10022, US

(73) Assignee: METABOWERKE GMBH, NURTINGTON, DE (DE)

(21) Appl. No.: 12/299,033

(22) PCT Filed: May 5, 2007
(86) PCT No.: PCT/DE07/00811

§ 371 Date: Oct. 30, 2008

(30) Foreign Application Priority Data
May 5, 2006 (DE) 10 2006 020 962.1

(51) Int. Cl. H02K 1/06

(52) U.S. Cl. 310/156.32

(57) ABSTRACT

The invention relates to a brushless electric motor, comprising a stator and an armature with armature teeth and permanent magnets in accumulative order, the armature being made from a laminated core with grooves and the armature teeth and grooves have a particular embodiment. The commutation time for the phase windings of the stator is selected such that subsequent control of the commutation time is not necessary, the torque being approximately equal at the start and the end of an armature stage.

The invention relates to a brushless electric motor according to claim 1.

Electronically commutated electric motors typically have a permanent magnet-excited rotor, wherein the rotor is either equipped with individual permanent magnets, or a multipole ring magnet is arranged on the rotor, and in a motor with a small diameter, the rotor itself is frequently made of a permanent magnet having multiple magnetized poles. The magnetization direction of the magnet or magnets of such rotors is mostly perpendicular to the air gap of the motor.

DE 101 24 436 A1 shows in an axial top view a diagram of a stator and a rotor of a brushless electric motor. The stator has a stator winding with winding phases connected in a star configuration, with the permanent magnets being arranged on the rotor body which is made of a sheet metal laminate. With such an arrangement of the permanent magnets on the rotor, the permanent magnets may disadvantageously detach from the rotor at high rotation speeds and due to high stress caused by temperature and other effects; in addition, there is a risk that the permanent magnets become demagnetized due to large magnetic fields at the stator.

Electric motors need to be flexibly controllable from a low to a high rotation speed under load and must be able to withstand overloads. A conventional electronically commutated permanent magnet-excited electric motor, which satisfies these requirements, is frequently difficult to install, because in many cases only a very limited space is available for the installation of such motor, which limits the outside diameter of the electric motor. For attaining high rotation speeds, the permanent magnet-excited rotor advantageously has a low field strength and a small number of poles on the stator.

Disadvantageously, a low field strength of the permanent magnets of the rotor and a small number of field poles on the stator more particularly limits the input power and hence also the torque of the electric motor due to the risk that the permanent magnet-excited rotor becomes demagnetized.

Advantageously, a high input power and a high rotation speed of the permanent magnet-excited electric motor can be attained if the magnetization direction of the permanent magnets of the rotor is not perpendicular to the air gap of the electric motor. A number of solutions are already known which implement this orientation of the permanent magnets relative to the air gap of the motor.

DE 197 23 302 A1 describes such solution. The rotor is formed with a reluctance-supported permanent magnet system, wherein the arrangement of the permanent magnets in the rotor is a collector arrangement. The rotor is made of a laminated core having rotor teeth and interposed slots. Permanent magnets, which are magnetized tangentially so that always two poles of the same polarity operate on one rotor tooth, are arranged in the slots. The magnetization direction of the permanent magnets is oriented parallel to the air gap of the motor.

U.S. Pat. No. 6,847,149 B2 describes an electric motor wherein the permanent magnets of the rotor are arranged in a collector arrangement along the rotor shaft in a slot extending perpendicular to the shaft. The slots of the rotor are formed by core members (rotor teeth), and these core members are individually non-rotatably connected with the rotor shaft. The rotor teeth have a specially formed pole face facing the air gap.

The construction of an electric motor of the described type is too complex and expensive for many applications.

U.S. Pat. No. 6,097,126 A describes a brushless DC motor with a permanent magnet-excited reluctance rotor of a particular type. A permanent magnet, which forms the poles on the rotor elements at the air gap to the stator, is arranged between the rotor elements having a cross-wise shape. The wiring pattern of the winding phases and the rotor steps are performed in a manner known from reluctance motors, so that the torque disadvantageously suffers from a corresponding ripple.

Frequently, only a small space is available for the installation of an electronically commutated electric motor. The outside the diameter of the electric motor is therefore limited, which makes it difficult to install the required field winding on the stator, if the rotor should have a sufficiently large diameter for attaining an adequate torque. This problem is in particular prevalent in special drives.

It is therefore an object of the invention to provide an inexpensive electronically commutated electric motor, which can be flexibly controlled and highly loaded and can withstand overloads, and which attains a relatively high torque and high rotation speed in relation to its size, while also exhibiting the smallest possible cogging and generating little noise as well as insignificant heat-up of the electric motor.

The object is attained with the features of the independent claim 1. Advantageous embodiments of the invention are recited in the other claims and in the specification.

Advantageously, with the special structure of the stator and the rotor of the electric motor a particularly soft transition of the rotor steps from one rotor step to the next rotor step is attained, thereby reducing torque ripple and noise generation of the electric motor, wherein the torque is approximately the same at the beginning and at the end of a rotor step, and the input power as well as the effective output power is significantly increased, and the electric motor can operate under high load. Moreover, due to the special structure of the electric motor, the commutation time of the winding phases need not be readjusted for increasing rotation speeds, because the commutation time can advance up to one quarter of a stator tooth width, without significantly affecting the efficiency of the electric motor.

The invention will now be described in more detail with reference to the drawing.

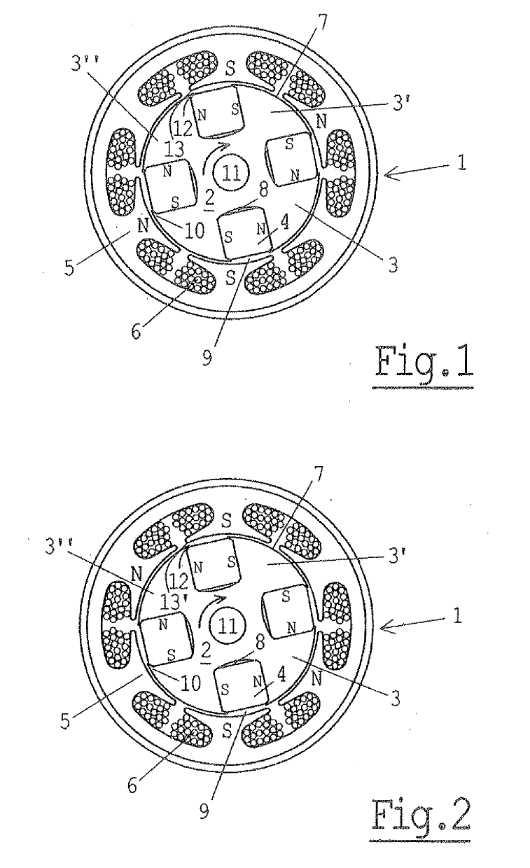

FIGS. 1 and 2 show in an axial top view a diagram of a stator and a rotor of the electric motor,

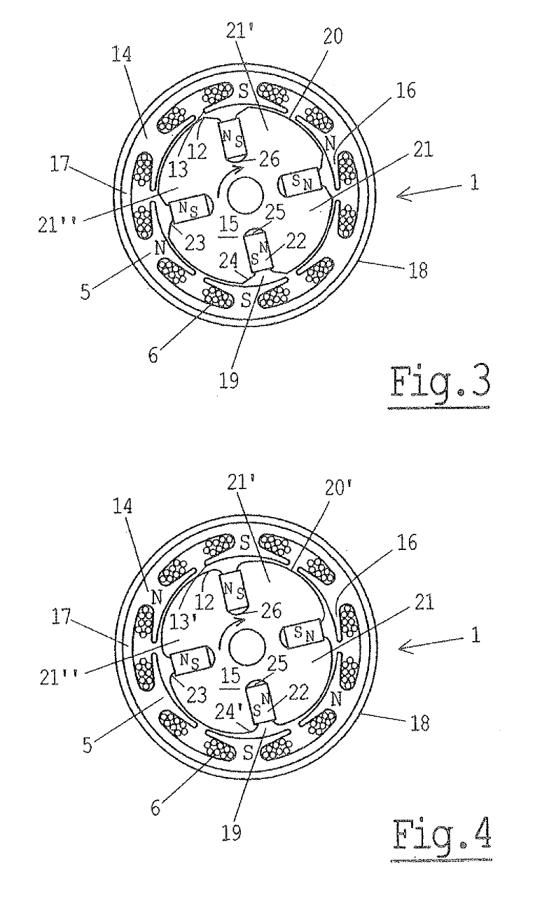

FIGS. 3 and 4 show in an axial top view an alternative diagram of a stator and a rotor of the electric motor,

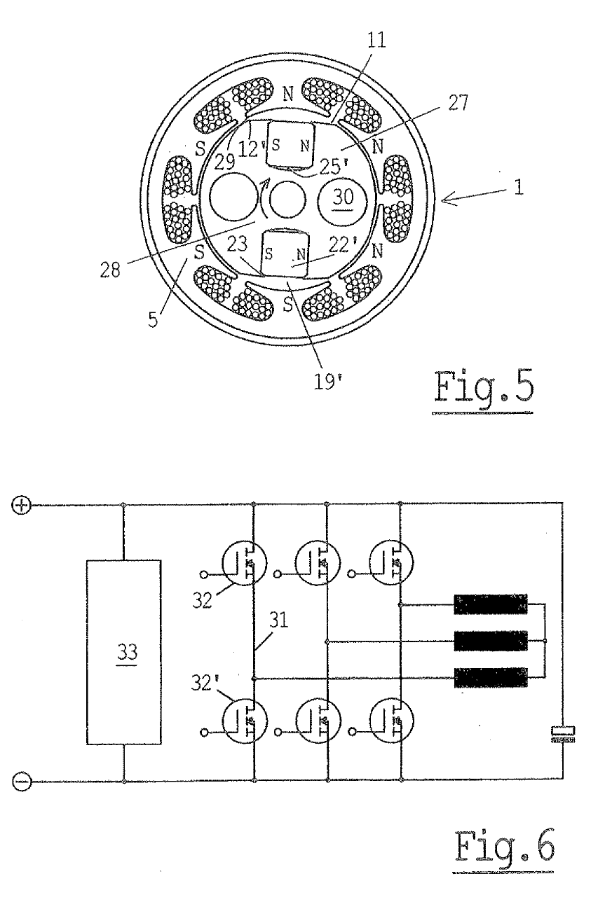

FIG. 5 shows in an axial top view another alternative diagram of a stator and a rotor of the electric motor, and

FIG. 6 shows a circuit diagram of an electronic controller for commutating the winding phases of the electric motor.

FIG. 1 shows in an axial top view a diagram of a stator and a rotor of the electric motor with an internal rotor, with winding phases on stator 1, and a rotor 2 with rotor teeth 3 and permanent magnets 4. The stator has, in a two-pole arrangement of the winding phases, six stator teeth 5 facing the rotor, wherein the winding phases each have two coils, and the coils 6 of the winding phases each surround a corresponding stator tooth 5. During motor operation, the winding phases are connected to a current source so that the opposing stator teeth on the stator each form poles with the same polarity, whereas adjacent stator teeth form teeth with an opposite polarity. This pole formation on the stator is indicated by N, S.

The rotor 2 is implemented as a permanent magnet-excited reluctance rotor. The rotor teeth 3 of rotor 2 form the pole faces 7 of the PM-excited rotor facing the stator. The permanent magnets 4 are arranged along the rotor shaft in a slot 8 oriented perpendicular to the shaft in a collector arrangement, with the corresponding pole faces of the permanent magnets facing the rotor tooth 3 forming poles of the same polarity, which at the air gap form the pole fields towards the stator. The width of the slots 8 of rotor 2 corresponds to the height of the permanent magnets 4, wherein the slot opening 9 of slots 8 can be smaller than the height of the permanent magnets. The rotor teeth 3 have projections 10 facing the slot opening to prevent the permanent magnets from a being ejected from the slots. The ratio of stator teeth to rotor teeth is 3:2.

For attaining a high efficiency of the motor, the width of the slot opening 9 of slots 8 of the rotor is preferably at least approximately half the width of a stator tooth 5, and at most plus approximately the width of a stator slot opening. The width of the permanent magnets in the direction towards the shaft is determined by the desired field strength towards the air gap; the smaller the mutual gap between the permanent magnets in the region of the shaft, the higher the field strength at the rotor teeth facing the air gap. The rotor teeth 3 are arranged contiguously on the shaft 11 of rotor 2 and are preferably formed of laminated metal plates, i.e., the rotor body is made of a sheet-metal laminate.

FIG. 1 shows the particular rotor position during startup and run-up, at which a rotor step is preferably terminated. Each trailing and leading rotor tooth 3′ is approximately at the center in relation to the adjacent stator teeth with opposite polarity, and the leading edge 12 of each following leading rotor tooth 3″ is, in relation to the rotation direction of the rotor, approximately at the edge 13 of the first stator tooth of the adjacent stator teeth with opposite polarity.

The rotor steps are terminated by reversing the polarity of the winding phases.

FIG. 2 shows the finished rotor step during startup and run-up due to a polarity change of the winding phases, with the next rotor step starting at the same time. The leading edge 12 of the rotor tooth 3″ is how located, in relation to the rotation direction of the rotor, approximately at the leading edge 13′ of the second stator tooth of the adjacent excited stator teeth having a different polarity.

With this arrangement of the switching processes of the rotor steps, the torque at the beginning and at the end of a rotor step is approximately identical, so that the commutation time of the winding phases needs no longer be readjusted with increasing rotation speed, because the commutation time can advance by a quarter of a stator tooth width, without significantly affecting the efficiency of the electric motor.

A complete revolution of the rotor can occur with twelve rotor steps as well as with six rotor steps, with the distance of a rotor step corresponding to the width of half a stator tooth, or the distance corresponding to the width of half a stator tooth plus the respective width of a slot opening.

Frequently, only a limited space is available for an electric motor. Such electric motor must be properly designed in order to attain an adequate torque during startup and at low rotation speeds with the rotor of an electronically commutated electric motor.

FIGS. 3 and 4 illustrate such an electric motor.

The sheet metal laminate 14 of the stator is designed so that the rotor 15 has a relatively large diameter. The stator teeth are constructed so that the stator teeth have long narrow pole horns 16, and the flux return 17 on the sheet metal laminate 14 of the stator is also designed to be very narrow, so that enough space remains for receiving the coil on the stator tooth. The flux of the magnetic fields, which cannot be taken up by the flux return 17 of the sheet metal laminate 14, is taken up by the iron cylinder 18 of the stator. This iron cylinder 18 includes bearing shields if the electric motor is flanged to a gear.

Such design of the sheet metal laminate of the stator is made possible because each coil of the winding phases surround only a single stator tooth, and these coils are preferably mechanically wound.

To attain a high rotation speed with only slight cogging, the volume of the permanent magnets is reduced accordingly. The spacing between the permanent magnets 22 and the stator teeth 5 is increased so that the slot openings 19 of the rotor 15 facing the air gap have from one pole face to the adjacent pole face, i.e., the pole face 20 of the rotor teeth 21 facing the air gap, at least approximately half the width of a stator tooth 5. The rotor teeth 21 are beveled with a projection 23 formed toward the permanent magnets 22, whereby the width of the slot opening 19 at the air gap is increased to at least approximately half the width of a stator tooth, and at most plus approximately the width of a stator slot opening, thereby preventing a decrease in the efficiency of the electric motor with the arrangement of permanent magnets having a small height. The bevel 24 of the rotor teeth 21 forming a projection toward the permanent magnets is depicted in FIG. 3 as a straight line.

As illustrated in FIG. 4, the pole face 20′ of the rotor teeth 21 facing the air gap as well as the bevel 24′ forming the projection can preferably be curved with a valuable curvature. This design advantageously produces a particularly soft transition of the rotor steps from one rotor step to the next rotor step, thereby further reducing torque ripple and cogging of the electric motor. The slots 25 receiving the permanent magnet 22 are preferably formed as a semi-circle at the slot bottom 26. With the slots of the rotor designed in this way, the pre-magnetized permanent magnets 22 can be securely pressed into the slots 25 without using an adhesive. On the front faces of the rotor thrust washers can be arranged, which can be provided with rotor fan blades for cooling the stator winding and for securing the permanent magnets.

FIGS. 1 to 4 illustrates an electric motor with a stator having six stator teeth, with a coil arranged on each stator tooth, and with a rotor having four poles. For very high rotation speeds, the rotor can also be constructed with two poles.

FIG. 5 shows an electric motor with a stator having six stator teeth and a rotor having two poles, so that the ratio of stator teeth to rotor teeth is 3:1. Each coil of the three-phrase stator winding surrounds two stator teeth, with the pole formation on the stator depicted by N, S. Each of the rotor teeth 27 is beveled with a projection 23 formed to face the permanent magnets 22′ in such a way that the width of the slot opening 19′ of the slots 25′ of the rotor 28 at the air gap is increased by approximately the width of a stator tooth. At the beginning of a rotor step, the leading edge 12′ of the rotor teeth 27 is preferably oriented, with respect to the rotation direction of the rotor, toward the leading edge 29 of the first stator tooth of the corresponding pole fields on the stator. A complete revolution of the rotor can hereby involve six rotor steps, but may only involve three rotor steps, with the distance of each rotor step corresponding approximately to the width of a stator tooth, or with the distance corresponding to the width of two adjacent stator teeth.

For reducing the weight of the rotor, the rotor teeth 3, 21, 27 can be provided with openings 30; these openings also reduce heat-up of the rotor.

By combining the special construction of the rotor and the special arrangement of the coils of the winding phases on the stator and through cooperation of this combination by controlling the rotating field on the stator with an electronic controller and by suitably orienting the rotor poles relative to the stator field, an approximately identical torque is attained at each rotor position. The effective output power is significantly increased in comparison, whereby the electric motor can be highly loaded, without running the risk that the permanent magnets are demagnetized.

The electric motor includes control electronics for connecting the winding phases to a current source.

FIG. 6 shows a circuit diagram of the electronic controller for commutating the winding phases. Each of the winding phases is connected at one end to a transistorized half bridge 31 and is at the other end connected in a star configuration, with a controller 33 being associated with the transistors 32; 32′.

The rotor position can be identified with conventional means, or the switching time of the winding phases is determined electronically, i.e., without using separate sensors.

For rapidly braking the motor, a winding phase is short-circuited via a switching element to the star-point or to another winding phase.

In the illustrated exemplary embodiment, the electric motor can also have a different number of pole pairs, and therefore a different number of stator teeth and rotor teeth, and the permanent magnets may also have different dimensions.

1. Brushless electric motor comprising
a stator (1) with stator teeth (5), which are each surrounded by a corresponding coil (6), and a rotor (2; 15) with rotor teeth (3; 21) and permanent magnets (4; 22) in a collector arrangement, wherein the stator teeth to rotor teeth ratio is 3:2, and with an electronic controller connectable to a current source for commutating a winding phases of the electric motor, wherein the electric motor is a permanent magnet-excited motor, with its rotor (2; 15) formed of a laminated core with rotor teeth (3; 21) and slots (8; 25) having permanent magnets (4; 22), and
wherein the rotor has slots having a slot opening (9; 19) of the slots of the rotor at an air gap in a region of the stator teeth is at least approximately half the width of a stator tooth (5), and at most plus approximately the width of a stator slot opening, and
the commutation time of the winding phases is selected so that the commutation time can advance with increasing rotation speed of the rotor up to a quarter of a stator tooth width without requiring readjustment,
wherein the commutation of the winding phases is adjusted during startup of the electric motor so that at the end of a rotor step the trailing and leading rotor tooth (3′; 21′) is each located approximately in the center between the adjacent stator teeth excited with the opposite polarity, and the leading edge (12) of the following leading rotor tooth (3″; 21″) is located, relative to the rotation direction of the rotor, approximately at the leading edge (13) of the first stator tooth of the adjacent stator teeth excited with opposite polarity, and that the next rotor step is initiated by reversing the polarity of the winding phases, wherein the leading edge (12) of the corresponding current leading and trailing rotor tooth (3″; 21″) is located, relative to the rotation direction of the rotor, approximately at the leading edge (13′) of the second stator tooth of the adjacent stator teeth excited with opposite polarity.

2. Electric motor according to claim 1,
wherein a distance between the permanent magnets (22; 22′) of the rotor and the stator teeth (5) is increased in that the rotor teeth (21; 27) have a bevel (24) with a projection (23) facing the permanent magnets (22, 22′).

3. Electric motor according to claim 2,
wherein the rotor teeth (21) having a pole face (20′) facing the air gap as well as the bevel (24′) forming the projection (23) is curved with a variable curvature, wherein the rotor teeth are connectedly formed from a laminated core.

4. Electric motor according to claim 1,
wherein the slots (25) for receiving the permanent magnets (22) are configured such that the magnetized permanent magnets can be pressed into the slots of the rotor without using an adhesive.

5. Electric motor according to claim 1,
wherein the stator teeth have small pole horns (16) and a flux return (17) on a sheet metal laminate (14) of the stator is designed to be narrow, wherein the flux of the magnetic fields that is not taken up by the flux return (17) is taken up by an iron cylinder (18) of the stator.

6. Electric motor according to claim 1,
further comprising thrust washers, and the rotor includes end faces, wherein the thrust washers are disposed on the end faces of the rotor, with the thrust washers having fan blades for cooling the stator winding, and also securing the permanent magnets of the rotor.

7. Electric motor according to claim 1,
wherein the distance of the rotor steps corresponds to the width of half a stator tooth, or the distance corresponds to the width of a stator tooth plus the width of a corresponding slot opening.

8. Electric motor according to claim 1,
wherein the rotor (28) has two-poles, and the ratio of the stator teeth to the rotor teeth is 3:1, wherein the width of the slot opening (19′) of the slots (25′) of the rotor (28) at the air gap corresponds approximately to the width of a stator tooth, and each of the coils of the stator winding surrounds two stator teeth, wherein each stator tooth is field-excited, and the leading edge (12′) of the rotor teeth (27) is oriented, in relation to the rotation direction of the rotor, towards the leading edge (29) of the respective first stator tooth of the corresponding pole fields on the stator.

9. Electric motor according to claim 8,
wherein a complete revolution of the rotor can be performed with six rotor steps, as well as with three rotor steps, in that the distance of each rotor step corresponds to the width of a stator tooth, or the distance corresponds to the width of two corresponding stator teeth.

10. Electric motor according to claim 9,
wherein, for optimizing the rotor, the rotor teeth (3, 21, 27) are provided with an opening (30) or with openings.
